(19) United States
(12) Patent Application Publication
(10) Pub. No.: US 2026/0166514 A1
(43) Pub. Date: Jun. 18, 2026

(54) GASEOUSLY-PARALLEL, FLUIDICALLY-SERIAL METAL HYDRIDE REACTOR ARCHITECTURE

(71) Applicant: JTEC ENERGY, INC., Atlanta, GA (US)

(72) Inventors: Julian Leland BELL, Decatur, GA (US); Christopher SMITH, Sandy Springs, GA (US); Stephen ZACK, Atlanta, GA (US)

(21) Appl. No.: 19/411,841

(22) Filed: Dec. 8, 2025

Related U.S. Application Data
(60) Provisional application No. 63/733,839, filed on Dec. 13, 2024.

(51) Int. Cl. B01J 19/00; B01J 31/12

(52) U.S. Cl. CPC B01J 19/0046; B01J 31/121; B01J 2219/00306; B01J 2219/00337; B01J 2219/00585

(57) ABSTRACT

A method of operating a metal hydride reactor system includes connecting thermal fluid channels of a first subset of reactors together in series and the gas ports to a first chamber, connecting thermal fluid channels of a second subset of reactors together in series and the gas ports to a second chamber. With each reactor at a different starting hydrogen concentration and substantially equal starting pressure, a first thermal fluid flows through the connected thermal fluid channels of the first subset to cause hydrogen desorption. A similar process occurs with the second subset and a second thermal fluid to cause hydrogen absorption. The method further includes heating a first exchange reactor separate from the first and second subsets to raise a temperature of its metal hydride bed, and cooling a second exchange reactor separate from the first and second subsets to reduce a temperature of its metal hydride bed.

### CROSS-REFERENCE TO RELATED APPLICATIONS

This application claims the benefit of U.S. Provisional Ser. No. 63/733,839, filed Dec. 13, 2024, entitled “Gaseously-Parallel, Fluidically-Serial Metal Hydride Reactor Architecture,” currently pending, the entire contents of which are incorporated by reference herein.

### BACKGROUND

Embodiments described herein relate generally to metal hydride absorbing/desorbing reactors, and more particularly, to systems and methods for more efficiently connecting and operating metal hydride absorbing/desorbing reactors.

When designing a metal hydride absorbing/desorbing system, it is advantageous to combine a large group of small reactors together to absorb/desorb in parallel, rather than desorbing from a single, large unitary reactor. Doing so provides a dramatically more stable pressure output than single-reactor desorption/absorption. It also allows individual, small reactors to be switched between groups when they are filled/exhausted, dramatically reducing the overall mass of the metal hydride system. However, these systems are limited in how wide of a concentration range they can operate over: if the concentration range is too wide, the reactors within the group will parasitically absorb/desorb and shrink the concentration range.

It is desirable to provide a system and method for connecting metal hydride reactors together to allow for advantageous parallel absorption and desorption, but without the above-mentioned restrictions in usable concentration range.

### BRIEF SUMMARY

Briefly stated, one example embodiment comprises a method of operating a metal hydride reactor system. The method includes providing a plurality of metal hydride reactors. Each of the reactors has a metal hydride bed in fluid communication with a gas port, a thermal fluid channel in thermal communication with the metal hydride bed, a thermal fluid inlet, and a thermal fluid outlet. The method further includes connecting the thermal fluid channels of a first subset of the reactors to each other in series between a first thermal fluid source and a first return line and connecting the gas ports of the first subset of the reactors to a common first chamber operating at a first pressure, connecting the thermal fluid channels of a second subset of the reactors to each other in series between a second thermal fluid source and a second return line and connecting the gas ports of the second subset of the reactors to a common second chamber operating at a second pressure lower than the first pressure. With each of the first subset of the reactors having its respective metal hydride bed at a different starting hydrogen concentration and at substantially equal starting pressures, a first thermal fluid flows from the first thermal fluid source through the connected thermal fluid channels of the first subset of the reactors to cause desorption of hydrogen stored in the metal hydride beds of the first subset of the reactors to the first chamber. The first thermal fluid has a first starting temperature. With each of the second subset of the reactors having its respective metal hydride bed at a different starting hydrogen concentration and at substantially equal starting pressures, a second thermal fluid flows from the second thermal fluid source through the connected thermal fluid channels of the second subset of the reactors to cause absorption of hydrogen from the second chamber into the metal hydride beds of the second subset of the reactors. The second thermal fluid has a second starting temperature that is lower than the first starting temperature. The method further includes heating a first exchange reactor separate from the first and second subsets of the reactors to raise a temperature of its metal hydride bed, and cooling a second exchange reactor separate from the first and second subsets of the reactors to reduce a temperature of its metal hydride bed.

In one aspect, the method further includes providing, for each of the reactors, a first valve at the thermal fluid inlet. In a further aspect, the first valve is a four-way, three position valve that includes a first inlet port selectable to couple the respective reactor to a source of the first thermal fluid, a second inlet port selectable to couple the respective reactor to the thermal fluid outlet of an adjacent one of the reactors, and a third inlet port selectable to couple the respective reactor to a source of the second thermal fluid. In a still further aspect, the method further includes providing, for each of the reactors, a second valve at the thermal fluid inlet, the second valve being a three-way, two-position valve including a first inlet port selectable to couple the respective reactor to a source of compressed gas, and a second inlet port selectable to couple the respective reactor to an outlet port of the first valve. In a yet further aspect, the method further includes connecting the thermal fluid outlet of the first exchange reactor to the first return line, flowing compressed gas from the source of compressed gas through the second valve of the first exchange reactor to expel first thermal fluid out of the thermal fluid channel of the first exchange reactor to the first return line, connecting the thermal fluid outlet of the second exchange reactor to the second return line, and flowing compressed gas from the source of compressed gas through the second valve of the second exchange reactor to expel second thermal fluid out of the thermal fluid channel of the second exchange reactor to the second return line.

In a still further aspect, the method further includes providing, for each of the reactors, an outlet valve at the thermal fluid outlet. In yet a further aspect, the outlet valve is a four-way, three position valve that includes a first outlet port selectable to couple the respective reactor to the first return line, a second outlet port selectable to couple the respective reactor to the thermal fluid inlet of an adjacent one of the reactors, and a third outlet port selectable to couple the respective reactor to the second return line.

In another aspect, a first leading reactor of the first subset of the reactors is connected in series between the first thermal fluid source and remaining reactors of the first subset of the reactors, and a second leading reactor of the second subset of the reactors is connected in series between the second thermal fluid source and remaining reactors of the second subset of the reactors. The method further includes disconnecting the thermal fluid channel of the first leading reactor from the thermal fluid channels of the remaining reactors of the first subset of the reactors and disconnecting the gas port of the first leading reactor from the first chamber, disconnecting the thermal fluid channel of the second leading reactor from the thermal fluid channels of the remaining reactors of the second subset of the reactors and disconnecting the gas port of the second leading reactor from the second chamber, connecting the thermal fluid channel of the first exchange reactor with the thermal fluid channels of the remaining reactors of the first subset of the reactors in series between the remaining reactors of the first subset of the reactors and the first return line, and connecting the gas port of the first exchange reactor to the common first chamber, and connecting the thermal fluid channel of the second exchange reactor with the thermal fluid channels of the remaining reactors of the second subset of the reactors in series between the remaining reactors of the second subset of the reactors and the second return line, and connecting the gas port of the second exchange reactor to the common second chamber.

In yet another aspect, the method further includes providing a membrane electrode assembly (MEA) including a first electrode, a second electrode, and a proton-exchange membrane sandwiched between the first and second electrodes. The first electrode is in fluid communication with the first chamber and the second electrode is in fluid communication with the second chamber.

In another example embodiment, a metal hydride reactor system includes a first chamber operating at a first pressure, a second chamber operating at a second pressure lower than the first pressure, a first thermal fluid source providing a first thermal fluid having a first starting temperature, a first return line for the first thermal fluid, a second thermal fluid source providing a second thermal fluid having a second starting temperature that is lower than the first starting temperature, a second return line for the second thermal fluid, and a plurality of metal hydride reactors. Each of the reactors has a metal hydride bed in fluid communication with a gas port, a thermal fluid channel in thermal communication with the metal hydride bed, a thermal fluid inlet, and a thermal fluid outlet. A plurality of valves are configured to selectively enable connection of the thermal fluid channels of a first subset of the reactors to each other in series between the first thermal fluid source and the first return line and connection of the gas ports of the first subset of the reactors to the first chamber. Each of the first subset of the reactors has its respective metal hydride bed at a different starting hydrogen concentration and at substantially equal starting pressure. The plurality of valves are further configured to enable connection of the thermal fluid channels of a second subset of the reactors to each other in series between the second thermal fluid source and the second return line and connection of the gas ports of the second subset of the reactors to the second chamber. Each of the second subset of the reactors has its respective metal hydride bed at a different starting hydrogen concentration and at substantially equal starting pressure. The plurality of valves are further configured to enable isolation of a first exchange reactor from the first and second subsets of the reactors and the first and second chambers, and isolation of a second exchange reactor from the first and second subsets of the reactors and the first and second chambers.

In one aspect, the plurality of valves includes, for each of the reactors, a first valve at the thermal fluid inlet. In a further aspect, the first valve is a four-way, three position valve that includes a first inlet port selectable to couple the respective reactor to the first thermal fluid source, a second inlet port selectable to couple the respective reactor to the thermal fluid outlet of an adjacent one of the reactors, and a third inlet port selectable to couple the respective reactor to the second thermal fluid source. In a still further aspect, the plurality of valves further includes, for each of the reactors, a second valve at the thermal fluid inlet. The second valve is a three-way, two-position valve including a first inlet port selectable to couple the respective reactor to a source of compressed gas, and a second inlet port selectable to couple the respective reactor to an outlet port of the first valve. In yet a further aspect, the plurality of valves further includes, for each of the reactors, an outlet valve at the thermal fluid outlet. In a still further aspect, the outlet valve is a four-way, three position valve that includes a first outlet port selectable to couple the respective reactor to the first return line, a second outlet port selectable to couple the respective reactor to the thermal fluid inlet of an adjacent one of the reactors, and a third outlet port selectable to couple the respective reactor to the second return line.

In another aspect, the system further includes a membrane electrode assembly (MEA) including a first electrode, a second electrode, and a proton-exchange membrane sandwiched between the first and second electrodes. The first electrode is in fluid communication with the first chamber and the second electrode is in fluid communication with the second chamber.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is schematic block diagram of a metal hydride reactor system in accordance with an example embodiment in operation with a membrane electrode assembly;

FIG. 2 is a side elevational cross-sectional view of a metal hydride reactor for use in a system in accordance with an example embodiment;

FIG. 3 is example pressure-composition-temperature (PCT) curves for a hydride material annotated to represent a desorption cycle of various reactors at generally the same starting pressure but different starting temperatures and hydrogen concentrations;

FIG. 4 is a schematic block diagram of a metal hydride reactor and valve arrangement in accordance with an example embodiment;

FIG. 5 is a schematic block diagram showing a flow arrangement for a desorbing subset of reactors from the reactor system in accordance with an example embodiment; and

FIG. 6 is a schematic block diagram showing cycling of reactors through absorbing and desorbing operations.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Referring to the drawings in detail, wherein like reference numerals indicate like elements throughout, there is shown a metal hydride reactor group 10 in accordance with an example embodiment. The metal hydride reactor group 10 may include a plurality of metal hydride reactors 12 that, as described in further detail below, may be connected in various configurations to absorb and/or desorb hydrogen for use in a metal hydride reactor system 2 that consumes and/or produces hydrogen.

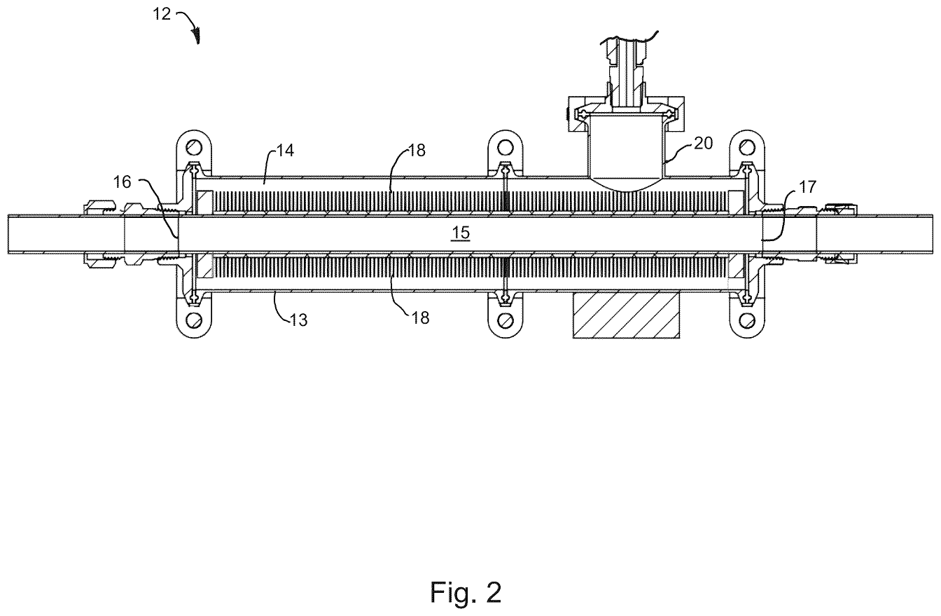

As shown in FIG. 2, each of the reactors 12 may be a pressure vessel 13 containing a metal hydride bed 14. For example, the vessel 13 may be a prefabricated seamless cylinder, filled with metal hydride and conductive structures through an engineered loading aperture. In other embodiments, the vessel 13 may be manufactured in two sections that are welded together after insertion of the metal hydride and thermal structures. In still other embodiments, the vessel 13 may be fabricated by spinning or forming around internal structures, ensuring precise integration of heat transfer components. Other vessel types may be used as well, with each vessel configuration being adapted for specific use cases including stationary energy storage, portable hydrogen supply, on-board vehicular hydrogen storage, or the like.

The metal hydride may be in powder form and include transition metals, rare earth alloys, intermetallic compounds, nanostructured composites, or the like. In one preferred embodiment, the metal hydride may have gravimetric capacity of at least about 1-7% hydrogen, a volumetric density greater than compressed hydrogen at about 350 bar, absorption kinetics permitting charging in less than about one hour, reversibility over at least about 100-1000 hydriding/dehydriding cycles with less than 20% loss of capacity, and tolerance to impurities (e.g., carbon monoxide, carbon dioxide, water vapor, and the like). However, the metal hydride may have different characteristics depending on the intended application of the metal hydride reactor system and operating conditions. In some embodiments, catalytic additives may be incorporated to enhance kinetics, while binders or coatings may be applied to improve particle durability. In some embodiments, the metal hydride powder may be made from AB5-based compounds, which are advantageous due to being inert. The specific alloy may be chosen to correlate with the operating pressures and temperatures utilized. However, other compound types may be used as well.

Repeated hydriding and dehydriding cycles may cause volume changes within metal hydride particles, which may lead to comminution, cracking, and/or density loss. Accordingly, certain precautions may be taken to address these issues. For example, the metal hydride beds 14 may utilize compartmentalized cell structures within the reactors that limit particle migration. Resilient matrix supports (e.g., polymer-metal composites) may be deployed to absorb expansion stress. Still further, metal hydride particles may be pre-compacted with conductive additives to maintain a uniform density, controlling powder densification. These steps can reduce stress concentrations on the walls of the vessel 13 and extend the life of a reactor 12.

In the example shown in FIG. 2, the metal hydride bed 14 may be coaxially arranged about a thermal fluid channel 15 extending longitudinally through the vessel 13 and in thermal communication with the metal hydride bed 14. The thermal fluid channel 15 includes a thermal fluid inlet 16 and a thermal fluid outlet 17 to respectively allow entry and exit of a thermal fluid (not shown) to the thermal fluid channel 15. The thermal fluid may be utilized to heat or cool the metal hydride bed 14 to respectively desorb or absorb hydrogen, as needed during operation. To more efficiently facilitate heat exchange between the thermal fluid channel 15 and the metal hydride bed 14, the reactor 12 may include heat fins 18 extending from the thermal fluid channel 15 into the metal hydride bed 14. The heat fins 18 provide additional surface area to dissipate heat from the thermal fluid channel 15 to the surrounding metal hydride bed 14, or vice versa when attempting to cool the metal hydride bed 14. However, additional or alternative aids for enhancing heat transfer may be used as well.

Although the metal hydride bed 14 is shown in FIG. 2 as coaxially surrounding the thermal fluid channel 15, other arrangements may be used as well, such as having the metal hydride bed 14 be centrally located within the vessel 13 and coaxially surrounded by an annular thermal fluid channel 15. In still other embodiments, the thermal fluid channel 15 may wind through the vessel 13 rather than extending straight through. In one example, the thermal fluid channel 15 may spiral through the vessel 13 along an interior wall thereof, surrounding the metal hydride bed 14. Other like arrangements may be used as well.

Each reactor 12 further may include a gas port 20 that may be in fluid communication with the respective metal hydride bed 14. The gas port 20 may allow for hydrogen or other hydrogen-containing fluids to enter the reactor 12 for absorption by the metal hydride bed 14 and/or exit the reactor 12 following desorption by the metal hydride bed 14. Although a single gas port 20 is shown in FIG. 2, in some embodiments, the reactor 12 may have separate gas ports for entrance and exit of hydrogen or hydrogen containing fluids. In other embodiments, multiple gas ports may be provided which may allow simultaneous entrance or exit of hydrogen or other hydrogen-containing fluids.

The metal hydride reactors 12 in the metal hydride reactor group 10 are preferably identical to one another, at least in terms of metal hydride bed 14 mass and composition, as well as mass of other components. Each of the reactors 12 should be as small as possible, with the most favorable ratio between metal hydride bed 14 mass and all other mass of the reactor 12. An ideal ratio of powder mass to the mass of other components is at least about 1:1, with higher ratios being preferred. As will be explained in further detail below, in example embodiments described herein, during operation, a first subset of the reactors 12 may be desorbing and a second subset of the reactors 12 may be absorbing. In addition, there may be reactors 12 that are not part of either subset and are being heated or cooled to prepare for rotation into one of the desorbing or absorbing subsets.

Each of the reactors 12 may be heated or cooled by circulation of a thermal fluid, which may be received in the thermal fluid channel 15. A first thermal fluid source 22 may provide a first thermal fluid having a first starting temperature, and a second thermal fluid source 24 may provide a second thermal fluid having a second starting temperature that is lower than the first starting temperature. The first and second thermal fluids may each be water, glycol, oil, or the like. The first thermal fluid may be used to heat one or more of the reactors 12 (e.g., to cause desorption of hydrogen stored therein) and therefore may have a first starting temperature (e.g., a temperature upon exiting the first thermal fluid source 22) in the range of about 60° C. to about 200° C., although other starting temperatures may be used as well. The first thermal fluid source 22 may be a vessel in thermal communication with a heater (not shown) or other source of heat to bring or maintain the first thermal fluid to the desired first starting temperature. After traversing the necessary reactors 12, the first thermal fluid may be directed to a first return line 23. The first return line 23 may be connected to a first return tank 27 with air space overhead to enable the first thermal fluid to be subsequently stored, although the first return line 23 may alternatively connect to other types of storage and/or disposal containers or devices. Returned thermal fluid in the first return tank 27 may be reheated for recycling back to the first thermal fluid source 22, cooled for later use in the second thermal fluid source 24, or retained for unspecified future use. In some embodiments, the first return tank 27 may be substituted for one of the first or second thermal fluid sources 22, 24 when the original source is empty. In still other embodiments, the first return line 23 may connect back to the first thermal fluid source 22 (with optional heating along the way, such as through a heat exchanger or the like) or directed to the second thermal fluid source 24 for use therein.

The second thermal fluid may be used to cool one or more of the reactors 12 (e.g., to cause absorption of hydrogen) and therefore may have a second starting temperature in the range of about 20° C. to about 25° C., although other starting temperatures may be used as well. The second thermal fluid source 24 may be a vessel in thermal communication with a heat sink (not shown) or other device for reducing or maintaining the second thermal fluid to its desired second starting temperature. After traversing the necessary reactors 12, the second thermal fluid may be directed to a second return line 25. The second return line 25 may be connected to a second return tank 29 with air space overhead to enable the second thermal fluid to be subsequently stored, although the second return line 25 may alternatively connect to other types of storage and/or disposal containers or devices. Returned thermal fluid in the second return tank 29 may be re-cooled for recycling back to the second thermal fluid source 24, heated for later use in the first thermal fluid source 22, or retained for unspecified future use. In some embodiments, the second return tank 29 may be substituted for one of the first or second thermal fluid sources 22, 24 when the original source is empty. In still other embodiments, the second return line 25 may connect back to the second thermal fluid source 24 (with optional cooling along the way, such as through a heat exchanger or the like) or directed to the first thermal fluid source 22 for use therein.

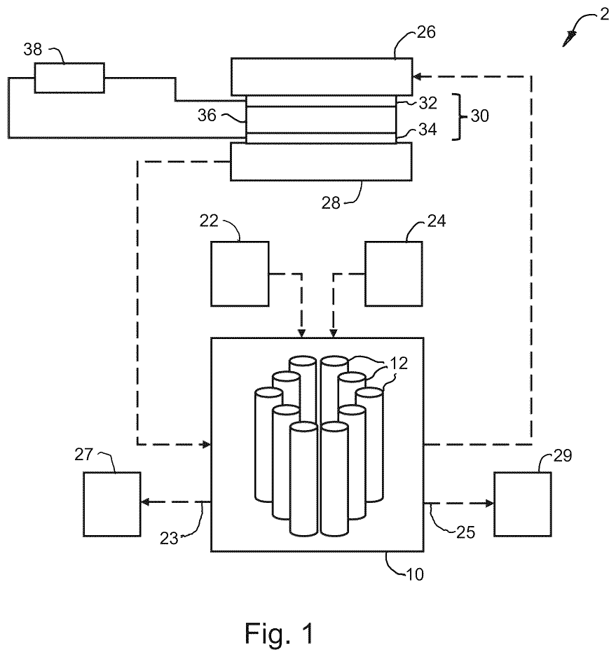

While the first and second thermal fluid sources 22, 24 are shown as separate vessels in fluid communication with the metal hydride reactor group 10 in FIG. 1, in some other example embodiments, the first and second thermal fluid sources 22, 24 may be formed as a continuous fluid loop where the first and second thermal fluids are the same fluid distinguished by their temperatures within the system, and heat sources and heat sinks may disposed along the fluid path to ensure the appropriate temperatures at specified locations within the system. In still other example embodiments, additional thermal fluid sources (not shown) may be provided.

A first chamber 26 may be provided as a destination for hydrogen desorbed by the reactors 12 and may be operating at a first pressure. A second chamber 28 may be provided as a source of hydrogen to be absorbed by the reactors 12 and may be operating at a second pressure lower than the first pressure. The first and second chambers 26, 28 may be part of, for example, a thermo-electrochemical converter utilizing a membrane electrode assembly (MEA) 30 that expands hydrogen to generate electricity, which is explained in further detail below. However, the first and second chambers 26, 28 need not be affiliated with a thermo-electrochemical converter and can, instead, be part of any other system operating on hydrogen or a working fluid containing hydrogen.

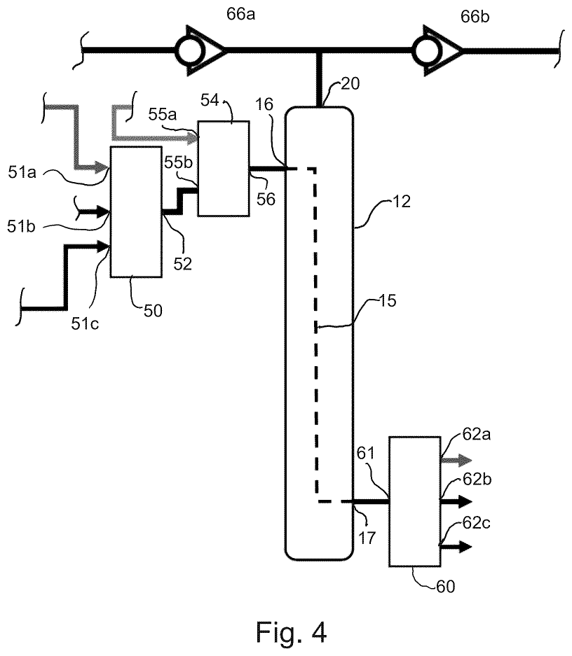

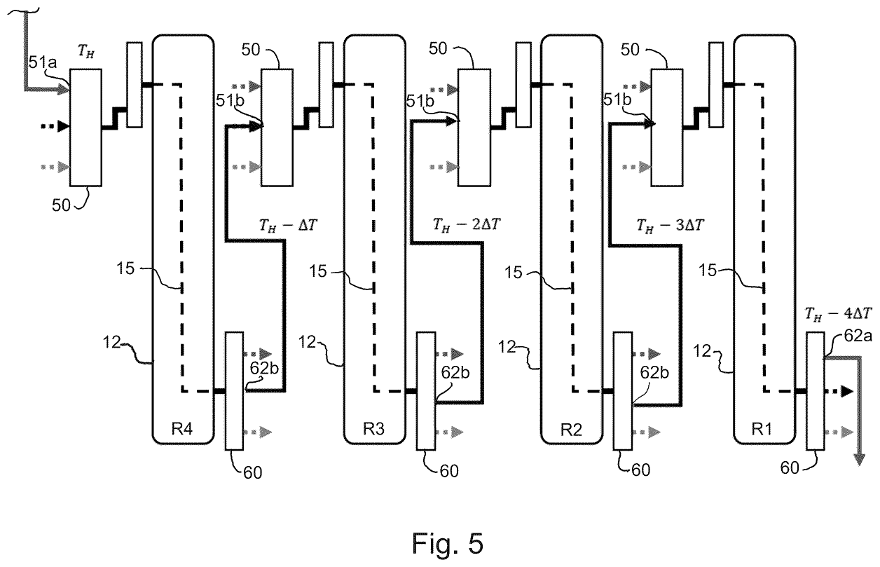

Valves may be provided for selectively connecting each of the reactors 12 to the appropriate components of the system 2. FIG. 4 schematically shows an example embodiment of several valves that may be used in connection with a reactor 12. In FIG. 4, a first valve 50 may be provided at the thermal fluid inlet 16 of the reactor 12 that is configured to switch fluid connections to the thermal fluid inlet 16 between multiple thermal fluid sources. In the example shown, the first valve 50 is a four-way, three position valve, which includes a first inlet port 51a, a second inlet port 51b, a third inlet port 51c, and an outlet port 52. The first inlet port 51a may be selectable to couple the reactor 12 to the first thermal fluid source 22 (i.e., the first thermal fluid may be received by the thermal fluid channel 15 from the first thermal fluid source 22). The second inlet port 51b may be selectable to couple the reactor 12 to an adjacent reactor 12 (see e.g., FIG. 5). That is, the thermal fluid received in the reactor 12 has already passed through at least one other reactor 12 in the reactor group 10. In this manner, reactors 12 may be serially connected to one another for flowing a thermal fluid. The third inlet port 51c may be selectable to couple the reactor to the second thermal fluid source 24 (i.e., the second thermal fluid may be received by the thermal fluid channel 15 from the second thermal fluid source 24). The first valve 50 may be electronically and/or manually actuable. While the first valve 50 is shown in the drawings as a four-way, three position valve, other valve types may be used as well, and may be connected directly to the thermal fluid inlet 16, or indirectly, such as via a manifold, tubing, another valve (e.g., second valve 54, described below), or the like.

The reactor 12 may further include an outlet valve 60 that may be provided at the thermal fluid outlet 17 thereof that is configured to direct thermal fluid emerging from the thermal fluid channel 15 to one of several optional destinations. In the example shown, the outlet valve 60 is a four-way, three position valve, which includes an inlet port 61, a first outlet port 62a, a second outlet port 62b, and a third outlet port 62c. The first outlet port 62a may be selectable to couple the reactor 12 to the first return line 23 (i.e., the first thermal fluid may be directed from the thermal fluid channel 15 to the first return line 23). The second outlet port 62b may be selectable to couple the reactor 12 to an adjacent reactor 12 (see e.g., FIG. 5). That is, the thermal fluid leaving the reactor 12 will pass to at least one other reactor 12 in the reactor group 10 as part of the serial thermal fluid connection. The third outlet port 62c may be selectable to couple the reactor to the second return line 25 (i.e., the second thermal fluid may be directed from the thermal fluid channel 15 to the second return line 25). The outlet valve 60 may be electronically and/or manually actuable. While the outlet valve 60 is shown in the drawings as a four-way, three position valve, other valve types may be used as well, and may be connected directly to the thermal fluid outlet 17, or indirectly, such as via a manifold, tubing, another valve, or the like.

In the example embodiment shown in FIG. 4, a second valve 54 may also be provided at the thermal fluid inlet 16 of the reactor 12, more particularly, between the first valve 50 and the thermal fluid inlet 16. The second valve 54 may be provided to enable a selective air purging operation to expel thermal fluid from the thermal fluid channel 15 such as, for example, when the reactor 12 is being switched between absorbing and desorbing subsets. For example, the second valve 54 may be a three-way, two-position valve, which includes a first inlet port 55a, a second inlet port 55b, and an outlet port 56. The first inlet port 55a may be selectable to couple the reactor 12 to a source of a compressed gas (not shown) or the like to enable purging of the thermal fluid channel 15. In one example, when the reactor 12 is removed from the desorbing subset of the reactor group 10 and is preparing to enter the absorbing group, the first inlet port 55a of the second valve 54 may be selected and the first outlet port 62a of the outlet valve 60 may be selected so that a compressed gas (e.g., air, nitrogen, or the like) may enter the thermal fluid channel 15 to move any remaining thermal fluid into the first return line 23. The second inlet port 55b of the second valve 54 may be connected to the outlet port 52 of the first valve 50 for admitting thermal fluid directed by the first valve 50 into the thermal fluid inlet 16. The second valve 54 may be electronically and/or manually actuable. While the second valve 54 is shown in the drawings as a three-way, two-position valve, other valve types may be used as well, and may be connected directly to the thermal fluid inlet 16, or indirectly, such as via a manifold, tubing, another valve, or the like.

While the example embodiment is shown in FIG. 4 as having a combination of a first valve 50 and a second valve 54, it may also be possible to combine the functionalities thereof into a single valve body, or to divide functionalities into additional valve bodies. Similarly, although the outlet valve 60 is shown as a single valve body, the functionalities may be divided into multiple valve bodies.

Additional valves may be provided in fluid communication with the gas port 20 of the reactor 12 for selectively connecting the gas port 20 (and more specifically, the metal hydride bed 14 (FIG. 2) therein) to one of the first and second chambers 26, 28 for inflow or outflow of hydrogen or a working fluid containing hydrogen. In the example embodiment shown in FIG. 4, such valves are shown in the form of first and second hydrogen check valves 66a, 66b. The first hydrogen check valve 66a allows flow out of the reactor 12 toward the first chamber 26. The first hydrogen check valve 66a may be configured to open at a peak pressure experienced during the desorption process within the reactor 12 and to close at or slightly below a lowest pressure experienced during desorption in the reactor 12. The second hydrogen check valve 66b allows flow into the reactor 12 from the second chamber 28. The second hydrogen check valve 66b may be configured to open at a minimum vacuum pressure differential to allow flow into the reactor 12 when the reactor is acting as an absorber. Connections of reactors 12 to the first or second chamber 26, 28 may be said to be in “parallel” since the hydrogen (or working fluid containing hydrogen) is not intended to pass through any other reactor 12 en route to the respective first chamber 26 or second chamber 28. Although the valves connecting the gas port 20 of the reactor 12 to the first or second chambers 26, 28 are shown as check valves, other valve types may be used as well, such as electronic or manually operable flow valves, or the like. Such valves may be connected directly to the gas port 20, or indirectly, such as via a manifold, tubing, another valve, or the like.

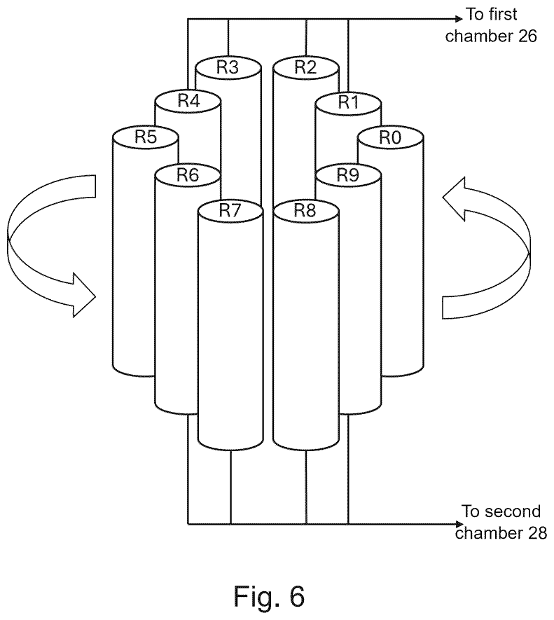

FIG. 5 shows an example of a subset of reactors 12 that have their respective thermal fluid channels 15 connected to each other in series in one example embodiment. The reactors 12 in FIG. 5 belong to a subset for desorbing hydrogen to the common first chamber 26 (FIGS. 1, 6), for example. For ease of identification, the reactors 12 in FIG. 5 are designated as R1-R4. In FIG. 5, the reactor R4 is a “leading reactor” as it is the first in the series of the connected reactors 12 to receive the first thermal fluid. A position of the first valve 50 of reactor R4 may therefore be selected to enable fluid communication with the first thermal fluid source 22 (FIG. 1) via the first inlet port 51a. Thus, hot first thermal fluid is able to enter the thermal fluid channel 15 of reactor R4 to heat the metal hydride bed 14 (FIG. 2) to cause desorption of hydrogen for passage to the common first chamber 26. The outlet valve 60 of reactor R4 may have a position selected to enable fluid communication to the next reactor R3 via the second outlet port 62b, and is therefore connected to the second inlet port 51b of reactor R3. The first thermal fluid similarly passes through the thermal fluid channel 15 of reactor R3 and exits via the second outlet port 62b of the outlet valve 60 of reactor R3 to flow to the second inlet port 51b of reactor R2. The first thermal fluid also passes through the thermal fluid channel 15 of reactor R2 and exits via the second outlet port 62b of the outlet valve 60 of reactor R2 to flow to the second inlet port 51b of reactor R1. Reactor R1 is the last in the series of the desorbing subset of reactors 12, so that the first thermal fluid passes through the thermal fluid channel 15 thereof and exits through the outlet valve 60 via the first outlet port 62a to the first return line 23.

A similar arrangement may be made for a subset of reactors 12 for absorbing hydrogen from the second chamber 28. FIG. 6, for example, shows the earlier-described four desorbing reactors R1-R4 connected to each other and to the common first chamber 26, while showing four absorbing reactors R6-R9 connected to each other and to the common second chamber 28. For the absorbing subset, reactor R9 is a “leading reactor” as it is the first in the series of the connected reactors 12 to receive the second thermal fluid. Although the specific connections are not shown in the drawings, the absorbing reactors R6-R9 may be connected in series similar to those shown in FIG. 5 for the desorbing reactors R1-R4, but configured for second thermal fluid flow. For example, a position of the first valve 50 of reactor R9 may be selected to enable fluid communication with the second thermal fluid source 24 via its first inlet port 51c. Cool second thermal fluid may be able to enter the thermal fluid channel 15 of reactor R9 to cool the metal hydride bed 14 (FIG. 2) to cause absorption of hydrogen received from the common second chamber 28. The outlet valve 60 of reactor R9 may have a position selected to enable fluid communication to the next reactor R8 via its second outlet port 62b, and is therefore connected to the second inlet port 51b of reactor R8. The second thermal fluid similarly passes through the thermal fluid channel 15 of reactor R8 and exits via the second outlet port 62b of the outlet valve 60 of reactor R8 to flow to the second inlet port 51b of reactor R7. The second thermal fluid also passes through the thermal fluid channel 15 of reactor R7 and exits via the second outlet port 62b of the outlet valve 60 of reactor R7 to flow to the second inlet port 51b of reactor R6. Reactor R6 is the last in the series of the absorbing subset of reactors 12, so that the second thermal fluid passes through the thermal fluid channel 15 thereof and exits through the outlet valve 60 via the first outlet port 62a to the second return line 25.

In operation, it may be desirable to isolate certain of the reactors 12 that have exhausted their hydrogen supply and/or reached hydrogen saturation from the absorbing and desorbing subsets described above. In this manner, the isolated reactors 12 may be prepared for subsequent usage in one of the operable reactor 12 subsets. For example, in FIG. 6, reactor R0 is not part of the desorbing subset R1-R4 nor the absorbing subset R6-R9 and is therefore considered an “exchange reactor” since, while the operable reactor subsets are absorbing and desorbing, reactor R0 may be saturated with hydrogen and be heated to raise its metal hydride bed 14 to a desired temperature (as explained in further detail below) so that R0 may subsequently join the desorbing subset when ready. For this purpose, reactor R0 may have its first inlet port 51a selected to connect to the first thermal source 22 (or to another source of thermal fluid for heating the reactor R0) and its first outlet port 62a selected to connect to the first thermal return line 23 or the like. Reactor R5 is a similar exchange reactor in that it may be empty of hydrogen and can be cooled to reduce its metal hydride bed 14 to a desired temperature (as explained in further detail below) so that R5 may subsequently join the absorbing subset when ready. For this purpose, reactor R5 may have its third inlet port 51c selected to connect to the second thermal fluid source 24 (or to another source of thermal fluid for cooling the reactor R5) and its third outlet port 62c selected for connection to the second thermal return line 25 or the like. As described earlier, prior to the heating/cooling connections, a compressed gas may be used to expel any thermal fluid remaining in the thermal fluid channels 15 of reactors R0, R5 from the previous operation cycle.

As will be explained in further detail below, a reactor 12 may only partially absorb or desorb hydrogen in a particular cycle before being “moved” to its next “position” in the system. For example, reactor R4, the “leading” reactor in the desorbing subset shown in FIGS. 5 and 6, will have exhausted its hydrogen content when the cycle performed with reactor R4 in its current position is completed. Thus, before the next cycle begins, reactor R4 may have its thermal fluid channel 15 disconnected from the thermal fluid channels 15 of the remaining reactors R1-R3 of the desorbing subset and have its gas port 20 disconnected from the first chamber 26, and will effectively become an exchange reactor taking the place of reactor R5. Reactor R3 may have its first valve 50 adjusted to connect directly (e.g., via its first inlet port 51a) to the first thermal fluid source 22, effectively taking the place of reactor R4. Reactor R2 may effectively take the place of reactor R3 (although no changes to positions the first valve 50 and outlet valve 60 are necessary in the shown embodiment). Reactor R1 may effectively take the place of reactor R2, with its outlet valve 60 adjusted to connect to the thermal fluid inlet 16 of reactor R0 (saturated with hydrogen), which is no longer an exchange reactor but instead has effectively taken the place of reactor R1. The thermal fluid channel 15 of reactor R0 is therefore connected in series between the remaining reactors R1-R3 of the desorbing subset and the first return line 23. The gas port 20 of reactor R0 may also connect to the common first chamber 26 to supply desorbed hydrogen. In a similar manner, reactor R9 may exit the absorbing subset to become an exchange reactor that is heated to prepare for desorbing, while reactors R6-R8 advance in position and exchange reactor R5 may enter the absorbing subset to effectively take the place of reactor R6. This step rotation may occur after each cycle so that, for example, reactor R1 has its hydrogen concentration sequentially depleted over four cycles as it moves from its initial position shown in FIGS. 5 and 6 to the position shown occupied by reactor R4 in FIGS. 5 and 6.

The methods and systems described herein seek to leverage a constant, or at least highly predictable, temperature change of a thermal fluid traversing a particular reactor 12. In other words, a thermal fluid may have a starting temperature T upon entering the thermal fluid inlet 16 of a first reactor 12 in a particular series, and the temperature of the thermal fluid will predictably change by ˜ΔT by the time it reaches the thermal fluid outlet 17 of the respective reactor 12. The thermal fluid will therefore have a temperature of ˜T±ΔT at the thermal fluid inlet 16 of the next reactor 12 in the series. For example, using the arrangement in FIG. 5, the first thermal fluid may enter reactor R4 at a first starting temperature of T_{H}, which will successively drop by ΔT as each reactor in the series is traversed until exiting reactor R1 at a temperature of T_{H}−4ΔT. Similarly, for an absorbing group, the second thermal fluid may enter reactor R6 at a second starting temperature of T_{C}, which will successively rise by ΔT as each reactor in the series is traversed until exiting reactor R9 at a temperature of T_{C}+4ΔT. The achievable temperature change across a reactor 12 may be limited by hysteresis of the metal hydride and powder kinetics. For example, exceeding an ideal ΔT can lead to a pressure reduction due to parasitic absorption. Beyond an “ideal” operating condition for a reactor 12, disproportionate reductions in performance are likely. This limitation may further constrain the minimum number of reactors 12 required for each of the absorber and desorber subsets. Although four reactors 12 are shown in FIGS. 5-6 for each subset, other numbers of reactors 12 may be used as well, depending on characteristics of the reactors 12 and the metal hydride beds 14 therein, system hydrogen capacity, and the like.

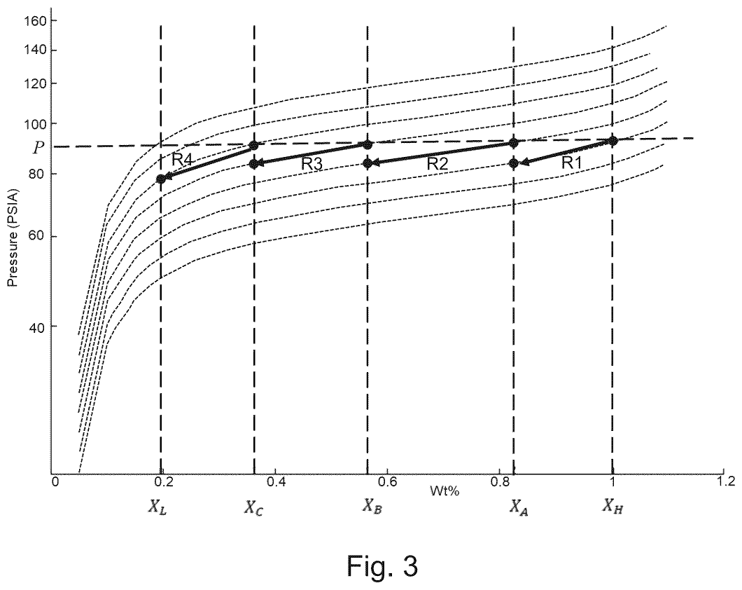

Knowing the temperature change across a reactor 12, the pressure-composition-temperature (PCT) curves for the metal hydride material in the reactor 12 can be used to determine different starting and ending hydrogen concentrations for each reactor 12 in the subset that will allow all of the reactors 12 in the subset to output at substantially equal starting pressures. FIG. 3 shows example PCT curves for a metal hydride material utilized in the reactor subset shown in FIG. 5. Each of the reactors R1-R4 begins the cycle at substantially equal starting pressure P, but each has a different starting hydrogen concentration: reactor R1 begins at X_{H}, which may be the highest hydrogen concentration used in the system (e.g., a saturated state); reactor R2 begins at X_{A}, reactor R3 begins at X_{B}, and reactor R4 begins at X_{C}.

As the first thermal fluid enters reactor R4 at first starting temperature T_{H} and exits at temperature T_{H}−ΔT, the hydrogen concentration of reactor R4 starts at X_{C} at pressure P and lowers to concentration X_{L} (which may be the lowest hydrogen concentration used in the system—e.g., an exhausted state) as hydrogen is desorbed from the metal hydride bed 14 and flows to the common first chamber 26. The first thermal fluid next enters reactor R3 at temperature T_{H}−ΔT and exits at temperature T_{H}−2ΔT, and the hydrogen concentration starting at X_{B} at pressure P lowers to concentration X_{C}. The first thermal fluid then enters reactor R2 at temperature T_{H}−2ΔT and exits at temperature T_{H}−3ΔT, and the hydrogen concentration starting at X_{A} at pressure P lowers to concentration X_{B}. Finally, the first thermal fluid enters reactor R1 at temperature T_{H}−3ΔT and exits at temperature T_{H}−4ΔT, and the hydrogen concentration starting at X_{H} at pressure P lowers to concentration X_{A}.

At hydrogen concentration X_{A}, for example, the properties of the metal hydride may be such that when reactor R1 cycles to the next position in the subset (e.g., taking the place of reactor R2 for the next cycle), reactor R1 now receives the first thermal fluid at its thermal fluid inlet 16 at temperature T_{H}−2ΔT, which restores the pressure in reactor R1 back to pressure P. In fact, the system may be designed using the known temperature changes so that each reactor 12 in the subset is restored back to pressure P for the subsequent cycle despite the differing hydrogen concentrations. Although not shown in the drawings, the absorbing subset of reactors 12 may operate in a similar manner to that shown in FIG. 3, but in reverse, i.e., the reactors R6-R9 would begin at a substantially equal starting pressure and would be cooled by the second thermal fluid flowing therein to enable each to absorb hydrogen up to the next known concentration.

Valve position changes in the system, such as at the first valve 50, second valve 54, outlet valve 60, or other valves, may be performed by a controller (not shown) or other computing device. For example, one or more of the valves may be in the form of a solenoid valve or similar electronically adjustable or actuatable valve in communication with the controller. The controller may communicate with one or more sensors (not shown) (e.g., pressure sensors, temperature sensors, flow rate sensors, or the like) that are distributed throughout the system 2 to indicate when reactor 12 connections require a change, or the like. Alternatively, valves may be adjusted manually by an operator. In some other embodiments, physical positions and connections of the reactors 12 may be swapped (e.g., by manual replacement or the like).

As explained above, one example application for use of the metal hydride reactor group 10 can be in connection with an MEA 30, to supply the pressurized working fluid upon which the MEA 30 acts to generate energy. Referring again to FIG. 1, the MEA 30 may include first and second electrodes 32, 34 which may be permeable to the working fluid (or at least hydrogen contained within the working fluid) and a proton-exchange membrane 36 sandwiched between the first and second electrodes 32, 34. The first and second electrodes 32, 34 may be made from suitable materials, such as carbon, ceramic, metal, metalorganic, combinations thereof, or the like and each have a thickness typically ranging from about 10 to about 300 micrometers. The proton-exchange membrane 36 may be made from polymeric material, ceramic material, combinations thereof, or the like, and may have a thickness typically ranging from about 10 to about 300 micrometers. Although one MEA 30 is shown, any number of MEAs 30 may be arranged together to form a “stack.”

The MEA 30 may be electrically coupled to an external load 38. In operation, electrons are stripped from the working fluid or hydrogen at the interface of the first electrode 32. The resulting ions (e.g., protons (H⁺) or other ions) are conducted through the proton-exchange membrane 36 toward the second electrode 34. Electrons flow in the circuit through the load 38 from the first electrode 32 and are supplied to the second electrode 34 and recombine with the conducted ions to reconstitute the working fluid or hydrogen therein.

The second chamber 28 may be in fluid communication with the second electrode 34 and the second pressure may be between about 0.1 and about 2 bar (absolute), although other pressure values for the second chamber 28 may be used, as desired. The first chamber 26 may be in fluid communication with the first electrode 32 and the first pressure may be between about 1 and about 50 bar (absolute), although other pressure values may be used for the first chamber 26, as desired. A ratio of the first pressure to the second pressure in this example configuration is preferably between about 2:1 and about 25:1, more preferably at about 20:1, although other pressure ratios may be utilized depending on the configurations and needs of the system. The MEA 30 therefore serves to generate electrical current through expansion of the working fluid (or hydrogen therein) from the first chamber 26 to the second chamber 28, with the metal hydride reactor group 10 serving to compress the hydrogen for return to the first chamber 26.

Although what has been described above is a metal hydride reactor group, alternative systems that perform a similar absorption/desorption process may be used as well. For example, a material other than metal hydride may be used to absorb or desorb alternative gasses, provided the material exhibits a similar difference between absorption and desorption pressures.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

We claim:

1. A method of operating a metal hydride reactor system, the method comprising:
providing a plurality of metal hydride reactors, each of the reactors having a metal hydride bed in fluid communication with a gas port, a thermal fluid channel in thermal communication with the metal hydride bed, a thermal fluid inlet, and a thermal fluid outlet;
connecting the thermal fluid channels of a first subset of the reactors to each other in series between a first thermal fluid source and a first return line and connecting the gas ports of the first subset of the reactors to a common first chamber operating at a first pressure;
connecting the thermal fluid channels of a second subset of the reactors to each other in series between a second thermal fluid source and a second return line and connecting the gas ports of the second subset of the reactors to a common second chamber operating at a second pressure lower than the first pressure;
with each of the first subset of the reactors having its respective metal hydride bed at a different starting hydrogen concentration and at substantially equal starting pressures, flowing a first thermal fluid from the first thermal fluid source through the connected thermal fluid channels of the first subset of the reactors to cause desorption of hydrogen stored in the metal hydride beds of the first subset of the reactors to the first chamber, the first thermal fluid having a first starting temperature;
with each of the second subset of the reactors having its respective metal hydride bed at a different starting hydrogen concentration and at substantially equal starting pressures, flowing a second thermal fluid from a second thermal fluid source through the connected thermal fluid channels of the second subset of the reactors to cause absorption of hydrogen from the second chamber into the metal hydride beds of the second subset of the reactors, the second thermal fluid having a second starting temperature that is lower than the first starting temperature;
heating a first exchange reactor separate from the first and second subsets of the reactors to raise a temperature of its metal hydride bed; and
cooling a second exchange reactor separate from the first and second subsets of the reactors to reduce a temperature of its metal hydride bed.

2. The method of claim 1, further comprising providing, for each of the reactors, a first valve at the thermal fluid inlet.

3. The method of claim 2, wherein the first valve is a four-way, three position valve that includes a first inlet port selectable to couple the respective reactor to a source of the first thermal fluid, a second inlet port selectable to couple the respective reactor to the thermal fluid outlet of an adjacent one of the reactors, and a third inlet port selectable to couple the respective reactor to a source of the second thermal fluid.

4. The method of claim 3, further comprising providing, for each of the reactors, a second valve at the thermal fluid inlet, the second valve being a three-way, two-position valve including a first inlet port selectable to couple the respective reactor to a source of compressed gas, and a second inlet port selectable to couple the respective reactor to an outlet port of the first valve.

5. The method of claim 4, further comprising:
connecting the thermal fluid outlet of the first exchange reactor to the first return line;
flowing compressed gas from the source of compressed gas through the second valve of the first exchange reactor to expel first thermal fluid out of the thermal fluid channel of the first exchange reactor to the first return line;
connecting the thermal fluid outlet of the second exchange reactor to the second return line; and
flowing compressed gas from the source of compressed gas through the second valve of the second exchange reactor to expel second thermal fluid out of the thermal fluid channel of the second exchange reactor to the second return line.

6. The method of claim 2, further comprising providing, for each of the reactors, an outlet valve at the thermal fluid outlet.

7. The method of claim 6, wherein the outlet valve is a four-way, three position valve that includes a first outlet port selectable to couple the respective reactor to the first return line, a second outlet port selectable to couple the respective reactor to the thermal fluid inlet of an adjacent one of the reactors, and a third outlet port selectable to couple the respective reactor to the second return line.

8. The method of claim 1, wherein a first leading reactor of the first subset of the reactors is connected in series between the first thermal fluid source and remaining reactors of the first subset of the reactors, and a second leading reactor of the second subset of the reactors is connected in series between the second thermal fluid source and remaining reactors of the second subset of the reactors, the method further comprising:
disconnecting the thermal fluid channel of the first leading reactor from the thermal fluid channels of the remaining reactors of the first subset of the reactors and disconnecting the gas port of the first leading reactor from the first chamber;
disconnecting the thermal fluid channel of the second leading reactor from the thermal fluid channels of the remaining reactors of the second subset of the reactors and disconnecting the gas port of the second leading reactor from the second chamber;
connecting the thermal fluid channel of the first exchange reactor with the thermal fluid channels of the remaining reactors of the first subset of the reactors in series between the remaining reactors of the first subset of the reactors and the first return line, and connecting the gas port of the first exchange reactor to the common first chamber; and
connecting the thermal fluid channel of the second exchange reactor with the thermal fluid channels of the remaining reactors of the second subset of the reactors in series between the remaining reactors of the second subset of the reactors and the second return line, and connecting the gas port of the second exchange reactor to the common second chamber.

9. The method of claim 1, further comprising:
providing a membrane electrode assembly (MEA) including a first electrode, a second electrode, and a proton-exchange membrane sandwiched between the first and second electrodes, wherein the first electrode is in fluid communication with the first chamber and the second electrode is in fluid communication with the second chamber.

10. A metal hydride reactor system comprising:
a first chamber operating at a first pressure;
a second chamber operating at a second pressure lower than the first pressure;
a first thermal fluid source providing a first thermal fluid having a first starting temperature;
a first return line for the first thermal fluid;
a second thermal fluid source providing a second thermal fluid having a second starting temperature that is lower than the first starting temperature;
a second return line for the second thermal fluid;
a plurality of metal hydride reactors, each of the reactors having a metal hydride bed in fluid communication with a gas port, a thermal fluid channel in thermal communication with the metal hydride bed, a thermal fluid inlet, and a thermal fluid outlet; and
a plurality of valves configured to selectively enable:
connection of the thermal fluid channels of a first subset of the reactors to each other in series between the first thermal fluid source and the first return line and connection of the gas ports of the first subset of the reactors to the first chamber, each of the first subset of the reactors having its respective metal hydride bed at a different starting hydrogen concentration and at substantially equal starting pressures,
connection of the thermal fluid channels of a second subset of the reactors to each other in series between the second thermal fluid source and the second return line and connection of the gas ports of the second subset of the reactors to the second chamber, each of the second subset of the reactors having its respective metal hydride bed at a different starting hydrogen concentration and at substantially equal starting pressures,
isolation of a first exchange reactor from the first and second subsets of the reactors and the first and second chambers, and
isolation of a second exchange reactor from the first and second subsets of the reactors and the first and second chambers.

11. The system of claim 10, wherein the plurality of valves includes, for each of the reactors, a first valve at the thermal fluid inlet.

12. The system of claim 11, wherein the first valve is a four-way, three position valve that includes a first inlet port selectable to couple the respective reactor to the first thermal fluid source, a second inlet port selectable to couple the respective reactor to the thermal fluid outlet of an adjacent one of the reactors, and a third inlet port selectable to couple the respective reactor to the second thermal fluid source.

13. The system of claim 12, wherein the plurality of valves further includes, for each of the reactors, a second valve at the thermal fluid inlet, the second valve being a three-way, two-position valve including a first inlet port selectable to couple the respective reactor to a source of compressed gas, and a second inlet port selectable to couple the respective reactor to an outlet port of the first valve.

14. The system of claim 11, wherein the plurality of valves further includes, for each of the reactors, an outlet valve at the thermal fluid outlet.

15. The system of claim 14, wherein the outlet valve is a four-way, three position valve that includes a first outlet port selectable to couple the respective reactor to the first return line, a second outlet port selectable to couple the respective reactor to the thermal fluid inlet of an adjacent one of the reactors, and a third outlet port selectable to couple the respective reactor to the second return line.

16. The system of claim 10, further comprising:
a membrane electrode assembly (MEA) including a first electrode, a second electrode, and a proton-exchange membrane sandwiched between the first and second electrodes, wherein the first electrode is in fluid communication with the first chamber and the second electrode is in fluid communication with the second chamber.
